(19) United States
(12) Patent Application Publication
(10) Pub. No.: US 2008/0074398 A1
(43) Pub. Date: Mar. 27, 2008

(54) Single-layer capacitive sensing device

(76) Inventor: David Gordon Wright, San Diego, CA (US)

Correspondence Address: BLAKELY, SOKOLOFF, TAYLOR & ZAFMAN LLP, 12400 Wilshire Boulevard, Seventh Floor, Los Angeles, CA, 90025, US

(21) Appl. No.: 11/528,054

(22) Filed: Sep. 26, 2006

(51) Int. Cl. G06F 3/041

(52) U.S. Cl. 345/173

(57) ABSTRACT

A touch-sensor device, and method of making same, having a sensor element, conductive sensor trace, and active electronic components disposed on a single-layer.

### TECHNICAL FIELD

This invention relates to the field of a capacitive sensing device.

### BACKGROUND

Computing devices, such as notebook computers, personal data assistants (PDAs), mobile communication devices, and portable entertainment devices (such as handheld video game devices, multimedia players, and the like) have user interface devices, which are also known as human interface devices (HID), that facilitate interaction between the user and the computing device. One type of user-interface device that has become more common is a touch-sensor pad (also known as a “touchpad”). A touchpad replicates mouse X/Y movement by using two defined axes, which contain a collection of sensor elements that detect the position of a conductive object such as a finger. Mouse right/left button clicks can be replicated by two mechanical buttons, located in the vicinity of the touchpad, or by tapping commands on the touchpad itself. The touchpad provides a user-interface device for performing such functions as positioning a cursor and selecting an item on a display. These touch pads may include multi-dimensional sensor arrays for detecting movement in multiple axes. The sensor array may include a one-dimensional sensor array to detect movement in one axis. The sensor array may also be two dimensional to detect movement in two axes.

One type of touchpad operates by way of capacitance sensing utilizing capacitive sensors. The capacitance detected by a capacitive sensor changes as a function of the proximity of a conductive object to the sensor. The conductive object can be, for example, a stylus or a user's finger. In a touch-sensor device, a change in capacitance detected by each sensor in the X and Y dimensions of the sensor array due to the proximity or movement of a conductive object can be measured by a variety of methods. Regardless of the method, usually an electrical signal representative of the capacitance detected by each capacitive sensor is processed by a processing device, which in turn develops electrical signals representative of the position of the conductive object in relation to the touch-sensor pad in the X and Y dimensions. A touch-sensor strip, slider, or button operates on the same capacitance-sensing principle.

Conventional capacitive touch pads are constructed on four-layer printed and two-layer printed circuit boards (PCBs). For example, U.S. Pat. Nos. 5,869,790 and 6,188,391 describe a four-layer and two-layer PCB, respectively. In a conventional four-layer touchpad, the first and second layers contain the horizontal and vertical sensor elements (also referred to as pads) and interconnecting sensor traces that form the capacitive sensor matrix; the third layer contains a ground plane; and, the fourth layer contains the controller and associated circuitry and interconnections to the capacitive sensor matrix. In some conventional two-layer touch pads, one layer contains the horizontal sensor elements and their corresponding interconnecting sensor traces; the second layer contains the vertical sensor elements and their interconnecting sensor traces; and, the controller resides on either of the two layers. It should be noted that in the field of capacitive touch pads, in reference to multiple-layer touch pads (e.g., “two-layer” or “four-layer” touch pads), the term “layer” is conventionally used to refer to a side of a non-conductive substrate upon which conductive material is disposed. It appears that the conventional meaning of the term “layer” is followed in U.S. Pat. Nos. 5,869,790 and 6,188,391, as discussed in further detail below.

FIG. 1 illustrates a four-layer touchpad as described in U.S. Pat. No. 5,869,790. The first layer 2 resides on the topside of the PCB having sensor traces 4 disposed in the vertical direction. These vertical sensor traces connect to vertically-aligned sensor elements disposed on the first layer (not shown). The second layer 12 resides on the underside of the PCB having sensor traces 13 disposed in the horizontal direction. These horizontal sensor traces connect to horizontally-aligned sensor elements disposed on the second layer (not shown). The third layer 3 is buried in the substrate of the PCB and houses the ground plane, which may connect to the topside or underside of the PCB using conductive traces and vias. Lastly, the fourth layer 14 includes the sensing circuit 15.

FIG. 2 illustrates one conventional two-layer touchpad described in U.S. Pat. No. 6,188,391. FIG. 2 of the present application is a reproduction of FIG. 2 of U.S. Pat. No. 6,188,391 with the addition of reference numbers for some components that were unlabeled in FIG. 2 of U.S. Pat. No. 6,188,391. The conventional two-layer touchpad illustrated in FIG. 2 of the present application contains the following: a capacitive sensor matrix 42, or array, having horizontal sensor elements 45 and vertical sensor elements 43 (represented by diamonds) and interconnecting horizontal sensor traces 44 and vertical sensor traces 46; and, a controller chip 48 disposed on the same side of the PCB 47 as the sensor array 42. Although the horizontal sensor traces 44 and vertical sensor traces 46 appear to reside on the same layer in FIG. 2, such is only for conceptual purposes to understand the functional inter-relationship of the horizontal and vertical sensor elements of the array 42. As described in regards to FIGS. 1A and 1B of U.S. Pat. No. 6,188,391, which would be apparent to one of ordinary skill in the art, the horizontal sensor elements 43 and their interconnecting row sensor traces 44 reside on a different layer than the vertical sensor elements 45 and their interconnecting column sensor traces 46. The controller chip 48 resides on one of these two different layers. Accordingly, the touchpad illustrated in FIG. 2 is a “two-layer” touchpad.

As noted by U.S. Pat. No. 6,188,391, the controller chip 48 and the sensor elements 43 and 45 are disposed on two non-overlapping regions of the same circuit board 42. As such, circuit board 47 must be substantially larger than the touch-sensor array 42 in order to provide area for mounting the controller chip 48, associated circuitry, and interconnections between the controller chip 48 and the sensor elements 43 and 45. U.S. Pat. No. 6,188,391 discusses that compactness of a four-layer touchpad is a principal advantage over the conventional two-layer touchpad shown in FIG. 2 of the present application. The touchpad printed circuit board of the four-layer design is no larger than the required sensitive area, such that no space is wasted. U.S. Pat. No. 6,188,391 states that this is a critical design feature for use in a notebook computer application. U.S. Pat. No. 6,188,391 further states that the industry has accepted a standard PC board size which is only slightly larger than the sensitive area 42 and, that for use in such standard applications, the two-layer configuration shown in FIG. 2 is not suitable at all. U.S. Pat. No. 6,188,391 purports that its invention allows the controller to be mounted on the back side of a two-layer printed circuit board, with both the horizontal and vertical elements disposed on the top layer without interference and, thereby, permits a two-layer touchpad to fit in the standard compact size particularly suited for laptop computers and similar applications. As such, U.S. Pat. No. 6,188,391 teaches away from mounting the controller on the same side of the PCB as the elements in order to achieve compactness of the resulting touchpad. U.S. Pat. No. 6,188,391 also asserts that two-layer touch pads that require the controller chip to be remotely located on the same side of the circuit board, away from the touch-sensitive area, do not perform an equivalent function as do conventional four-layer touch pads.

U.S. Pat. No. 6,188,391 describes the use of screen-printing carbon ink patterning to fabricate some of the conductive sensor traces to realize a two-layer board with the controller chip disposed on the opposite side (i.e., the second layer) of the board as the sensor elements and interconnecting conductive sensor traces (i.e., metal and conductive ink). FIG. 3 is a cross-section view illustrating the two-layer touch pad of the purported invention of U.S. Pat. No. 6,188,391. FIG. 3 of the present invention is a reproduction of FIG. 8B of U.S. Pat. No. 6,188,391 with the addition of the controller chip 110. It should be noted that in U.S. Pat. No. 6,188,391 the first layer (referred to as a single composite layer) contains both the horizontal sensor traces 69 and vertical sensor traces 104, as illustrated in FIG. 3. The second layer is on the underside of the printed circuit board and contains the controller chip 110 (which is not shown in the illustration of FIG. 8B of U.S. Pat. No. 6,188,391 but included in FIG. 3 of the present application for ease of understanding). Accordingly, the touchpad produced using screen-printing carbon ink patterning described in U.S. Pat. No. 6,188,391 is a two-“layer” touchpad because the conductive material that constitutes the controller and associated interconnection circuitry to the array is located on a different side (i.e., layer) of the non-conductive PCB substrate (e.g., constructed from FR4 PC board laminate) than that of the conductive material used to form the sensor array.

As can be seen from an inspection of FIG. 3 of the present application (and also FIG. 8B of U.S. Pat. No. 6,188,391), the topside layer containing both the horizontal and vertical sensor element layers is a “composite layer,” as it is referred to by U.S. Pat. No. 6,188,391. In such a composite layer, the vertical carbon ink interconnecting sensor traces 104 and the horizontal metal interconnecting sensor traces 69 reside in two different planes. The sensor elements 68 (sense pads illustrated by diamonds) and the horizontal metal interconnecting sensor traces 69 reside in a lower plane 130 than the vertical carbon ink sensor traces 104. The vertical carbon ink interconnecting sensor traces 104 reside on a substantially different plane 140 that is on top of the plane containing the sensor elements and the horizontal metal interconnecting sensor traces 130. Although some portion of the carbon ink sensor traces 104 may dip into the lower plane 130 in areas between the horizontal metal interconnecting sensor traces of the lower plane 130 (otherwise occupied by insulation 103), the carbon ink sensor traces 104 cannot reside in the same area of the lower plane 130 than is occupied by the horizontal metal interconnecting sensor traces 69 and their corresponding horizontal sense pads 68.

As mentioned above, U.S. Pat. No. 6,188,391 teaches mounting the controller on the opposite side of the PCB as the sensor elements in order to achieve compactness of the resulting touchpad. However, the placement of the controller on a side of the PCB opposite to the sensor elements adds manufacturing cost to a touchpad.

### BRIEF DESCRIPTION OF THE DRAWINGS

The present invention is illustrated by way of example, and not by way of limitation, in the figures of the accompanying drawings in which:

FIG. 1 illustrates a conventional four-layer touchpad PCB.

FIG. 2 illustrates one embodiment of sensor elements, conductive sensor traces, and controller disposed on a two-layer PCB.

FIG. 3 illustrates top and cross-section views of a conventional two-layer touchpad PCB.

FIG. 4 illustrates one embodiment of a single-layer touch-sensor device.

FIG. 5A illustrates a side view of one embodiment of a single-layer touch-sensor device.

FIG. 5B illustrates a side view of another embodiment of a single-layer touch-sensor device with the connector mounted to the opposite side as the active electronic components.

FIG. 6 illustrates one embodiment of sensor elements, conductive sensor traces, and active electronic components disposed on a single-layer touch-sensor device.

FIG. 7 illustrates top and cross-section views of one embodiment of a single-layer touch-sensor device.

FIG. 8A illustrates one embodiment of a single-layer touch-sensor device with tapered sensor elements

FIG. 8B illustrates a conventional linear touch-sensor slider.

FIG. 8C illustrates a conventional circular slider having a center button within the circular slider.

FIG. 9 illustrates a method to manufacture a single-layer touch-sensor device according to one embodiment of the present invention.

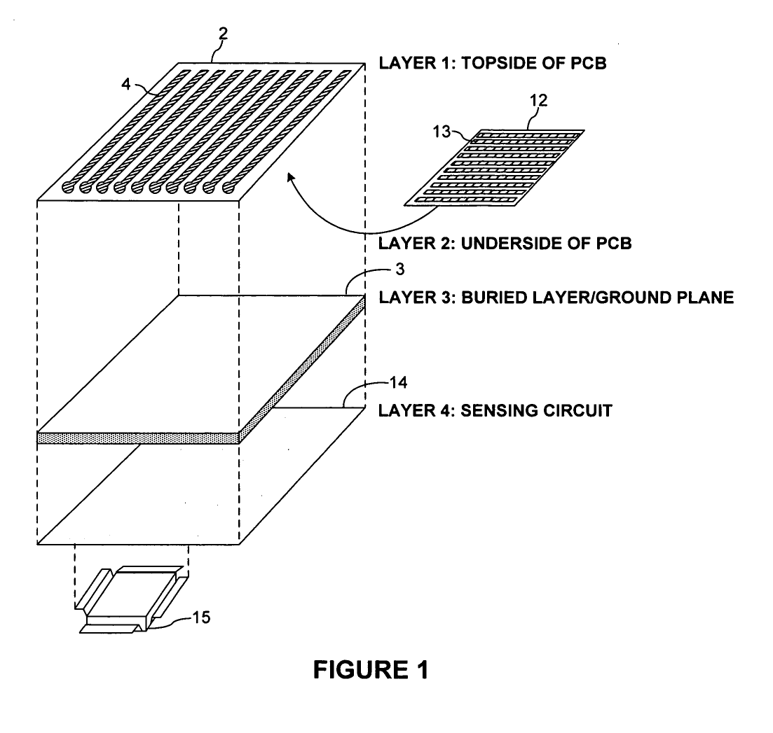

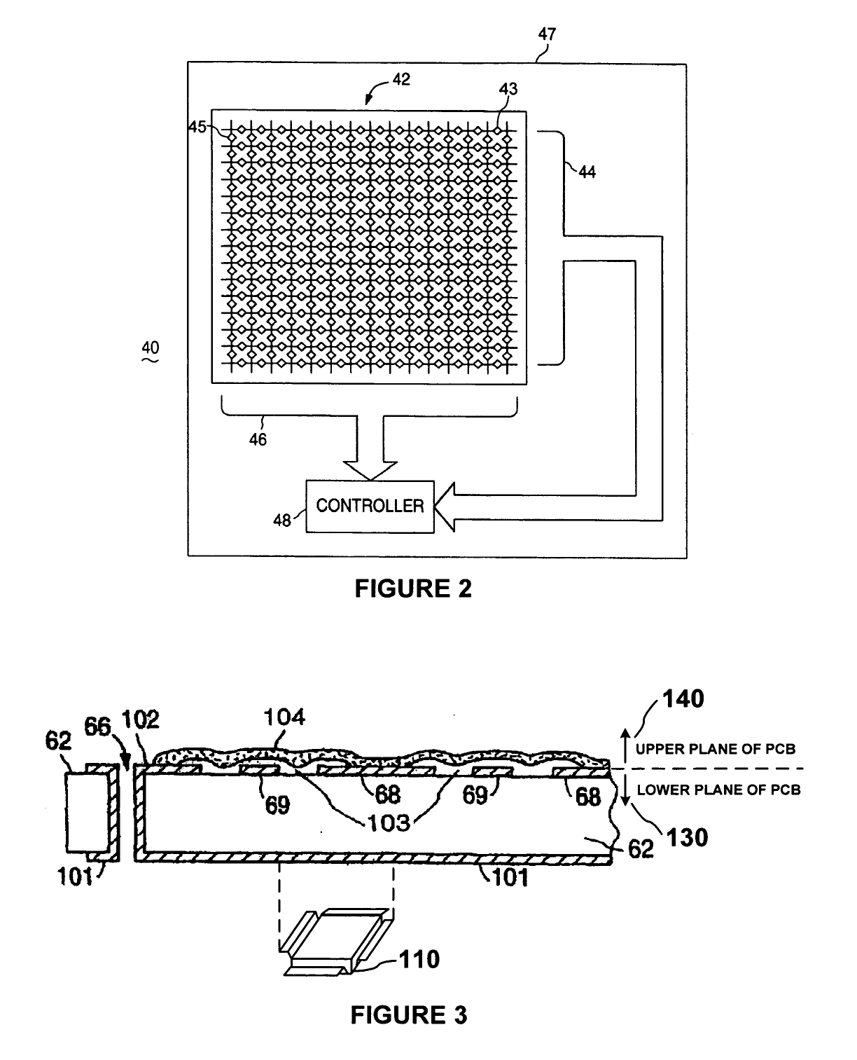

### DETAILED DESCRIPTION

In the following description, for purposes of explanation, numerous specific details are set forth in order to provide a thorough understanding of the present invention. It will be evident, however, to one skilled in the art that the present invention may be practiced without these specific details. In other instances, well-known circuits, structures, and techniques are not shown in detail, but rather in a block diagram in order to avoid unnecessarily obscuring an understanding of this description.

Reference in the description to “one embodiment” or “an embodiment” means that a particular feature, structure, or characteristic described in connection with the embodiment is included in at least one embodiment of the invention. The phrase “in one embodiment” located in various places in this description does not necessarily refer to the same embodiment.

In one embodiment, the methods and apparatus described herein may be used with electronic devices such as laptop computers, mobile handsets, and PDAs. Alternatively, the methods and apparatus herein may be used with other types of devices.

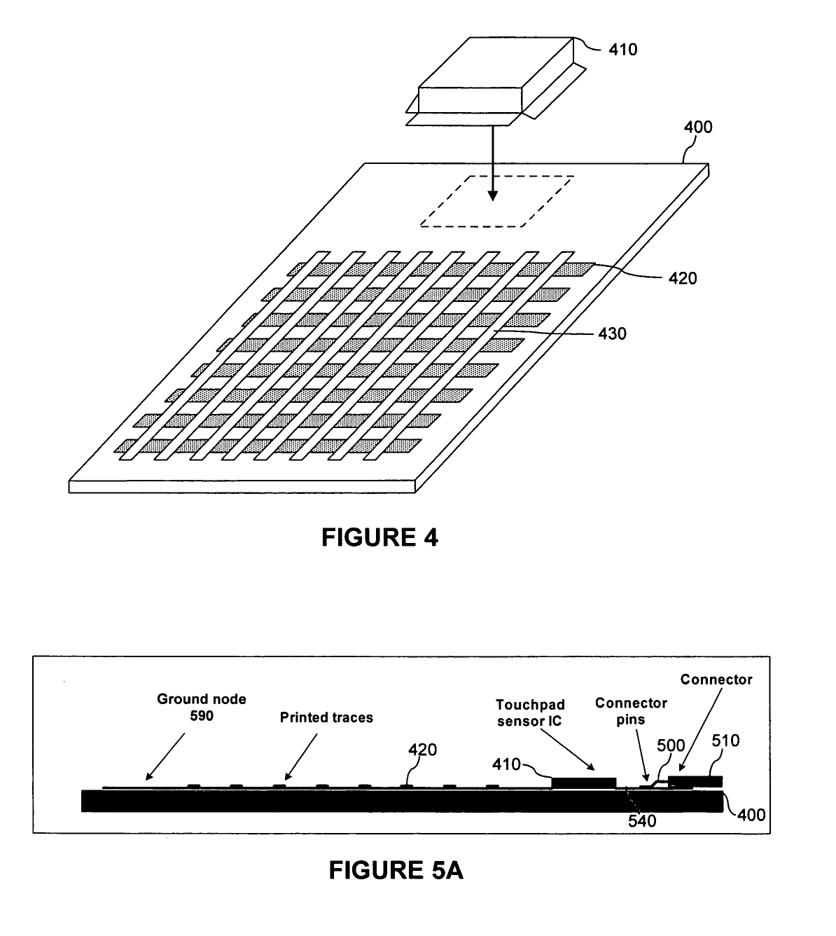

FIG. 4 illustrates one embodiment of a single-layer touch-sensor device on a non-conductive substrate. An example of the non-conductive substrate is FR-4 PCB laminate, which is composed of a woven fiberglass mat impregnated with a flame resistant epoxy resin. Alternatively, other non-conductive substrates may also be used, such as FR-2 (frequently made of paper impregnated with phenolic resin) and flex substrate (typically made from a polyimide film) PCB laminates.

The single-layer non-conductive substrate 400 houses one or more sensor elements, one or more sensor traces 420 and 430, and active electronic components 410 on a single layer of the non-conductive substrate 400 without any sensor traces residing on a different layer. In one embodiment, the sensor elements and the sensor traces of the touch-sensor device may be one element, for example, bars extending across the touch-sensor device. Alternatively, the sensor elements may have a shape with a dimension larger than that of a width of the sensor traces. Various exemplary shapes that may be used for the sensor elements are discussed below.

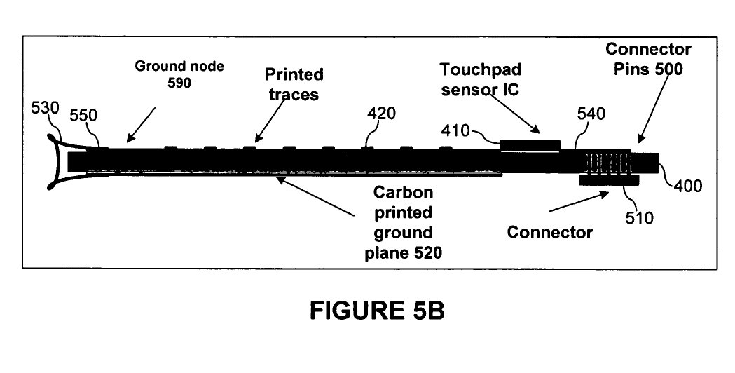

The single-layer non-conductive substrate 400 also includes a connector 510, as shown in FIG. 5A, which couples the active electronic components 410 to other components used in an electronic device. The active electronic components 410 may include a controller or other non-sensing circuitry for processing or for transmitting data measured on the sensor elements. Connector traces 540 couple the active electronic components 410 to the connector pins 500 of the connector 510, which may be used to connect to other external components in an electronic device. Other configurations known by those of ordinary skill in the art may be used to connect the active electronic components 410 to the connector 510.

The active electronic components 410 may reside on a common carrier substrate such as, for example, an integrated circuit (IC) die substrate, a multi-chip module substrate, or the like. Alternatively, the components may be one or more separate integrated circuits and/or discrete components. In one exemplary embodiment, the active electronic components 410 include a processing device, such as a Programmable System on a Chip (PSoC™) processing device, manufactured by Cypress Semiconductor Corporation, San Jose, Calif. Alternatively, processing device 210 may be one or more other processing devices known by those of ordinary skill in the art, such as a microprocessor or central processing unit, a controller, special-purpose processor, digital signal processor (DSP), an application specific integrated circuit (ASIC), a field programmable gate array (FPGA), or the like. Additionally, the processing device may include any combination of general-purpose processing device(s) and special-purpose processing device(s).

It should also be noted that the embodiments described herein are not limited to having a configuration of a processing device coupled to other external components of a electronic device, such as a host, but may include a system that measures the capacitance on the sensing device and sends the raw data to a host computer where it is analyzed by an application. In effect the processing that is done by processing device of the active electronic components 410 may also be done in the host.

In one embodiment, the connector 5 10 is mounted on the same side of the single-layer non-conductive substrate 400 (e.g., upper side of PCB) as the active electronic components 410, as described above and illustrated in FIG. 5A. Alternatively, the connector 510 may be mounted to the opposite side of the single-layer non-conductive substrate (e.g., underside of the PCB), as illustrated in FIG. 5B. In one embodiment, the connector 510 mounted on the opposite side may be a “thru-hole” connector where the connector body is mounted on the underside of the PCB, with connector pins 500 protruding through holes in the PCB, and making contact with conductive connector traces 540 on the upper side of the board, as illustrated in FIG. 5B. Alternatively, connector 510 may be mounted on the opposite side and connected to the active electronic components using other configurations known by those of ordinary skill in the art.

The single-layer non-conductive substrate 400 also includes a power node (not shown) and a ground node 590 disposed on the same side of the non-conductive substrate 400 as the one or more sensor elements, one or more sensor traces 420 and 430 and active electronic components 410. It should be noted that the sensor traces 430 may reside in the same plane as the ground node 590 and thus not shown in cross section FIGS. 5A and 5B due to its disposition behind the cross sectional view of ground node 590. The power node is coupled to an electronic device's system power supply. An example of a power supply of an electronic system may be batteries or AC power from an outlet. Further, the ground node 590 is coupled to a system ground connection of the electronic device. An example of a ground connection may be a common ground reference in the electronic device or a ground terminal from an outlet. A proximate ground plane or grid may also be used for the touch-sensor device. Such a proximate ground plane or grid minimizes electrostatic discharge and electromagnetic interference induced by external electronic components.

The active electronic components 410 may include a controller. A controller is known in the art; accordingly, a more detailed description is not provided. Alternatively, the active electronic components 410 may include other circuitry for sensing operations on the one or more sensor elements, and for transferring data to/from the connector 510, which may be coupled to additional circuit that is remote from the active electronic components 410. For example, the active electronic components may include a transceiver for transmitting the measured data to a remote host for detecting a presence of a conductive object, determining motion or position (both relative or absolute) of the conductive object, recognizing gesture events, or the like.

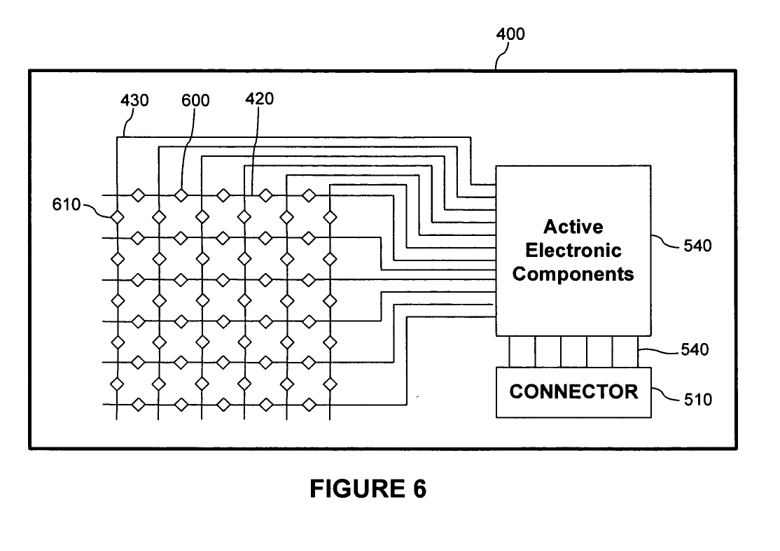

The one or more sensor elements 600 and 610, illustrated in FIG. 6, may include metal sensor elements. Diamonds are used to represent sensor elements 600 and 610 in FIG. 6. Alternatively, other shapes may be used to represent sensor elements 600 and 610; for example, squares, rectangles, triangles, hexagons, and circles may also be used. As previously noted, the sensor elements and the sensor trace of a particular row or column of the touch-sensor device may also be one element, such as a bar having, for example, a rectangular shape.

The one or more sensor traces 420 and 430 couple the sensor elements 600 and 610 to the active electronic components 410. Alternatively, sensor traces 420 and 430 may also couple one sensor element to another sensor element. The sensor traces 420 and 430 may be formed using a conductive ink. Carbon ink is frequently used as a conductive ink for PCB manufacturing, but alternate types of conductive inks or pastes, such as silver ink, may be used as a sensor trace. Alternatively, metal may also be used as a sensor trace. Though copper is frequently used as a metallic conductive trace in PCB manufacturing, alternate types of metals may also be used, such as gold, aluminum, or the like.

In one embodiment, a proximate ground plane 520 may be implemented on the underside (e.g., opposite side as the active electronic components). The proximate ground plane minimizes electrostatic discharge and electromagnetic interference induced by external electronic components. The proximate ground plane 520 may be formed, for example, as a sheet or as a grid. In one embodiment, the proximate ground plane 520 may be implemented using a carbon (or other conductive material) printed ground plane. Alternatively, the ground plane 520 may be implemented using conductive ink. This printed ground plane 520 may be connected to the system ground 550 using a pressure contact 530. The pressure contact 530 may be, in one embodiment, a spring metal clip making contact between the conductive lower surface of the board and a corresponding conductive area on the upper surface of the board. Alternatively, the pressure contact 530 may be a ground wire screwed to the board, or other types of pressure contacts known by those of ordinary skill in the art.

In another embodiment, the proximate ground plane 520 may be provided by a sheet of conductive material placed under the board, and attached to the board using either adhesive or a mechanically mechanism for fastening the sheet of conductive material to the board. The proximate ground plane 520 may be connected to electrical ground in a similar manner to those described for the carbon printed ground plane above. In another embodiment, the proximate ground plane 520 may be formed in other manners, for example, as a grid.

In one embodiment, a set of sensor traces 420 may be disposed in a first direction on a non-conductive substrate 400, as illustrated in FIG. 6. An example of the first direction is horizontal or vertical. Another set of sensor traces 430 may be disposed in a second direction. An example of the second direction is horizontal or vertical. The first direction may be orthogonal to the second direction. Alternatively, other angles between the first direction and second direction may be used; for example, 30°, 45°, and 60° may also be used. The set of sensor traces 420 disposed in the first direction is coupled to a first set of sensor elements 600 in the first direction. Further, the set of sensor traces 430 disposed in the second direction is coupled to a second set of sensor elements 610 in the second direction. The set of sensor traces 420 disposed in the first direction, the set of sensor traces 430 disposed in the second direction, and the active electronic components 410 reside on a single layer of the non-conductive substrate 400 without any sensor traces residing on a different layer.

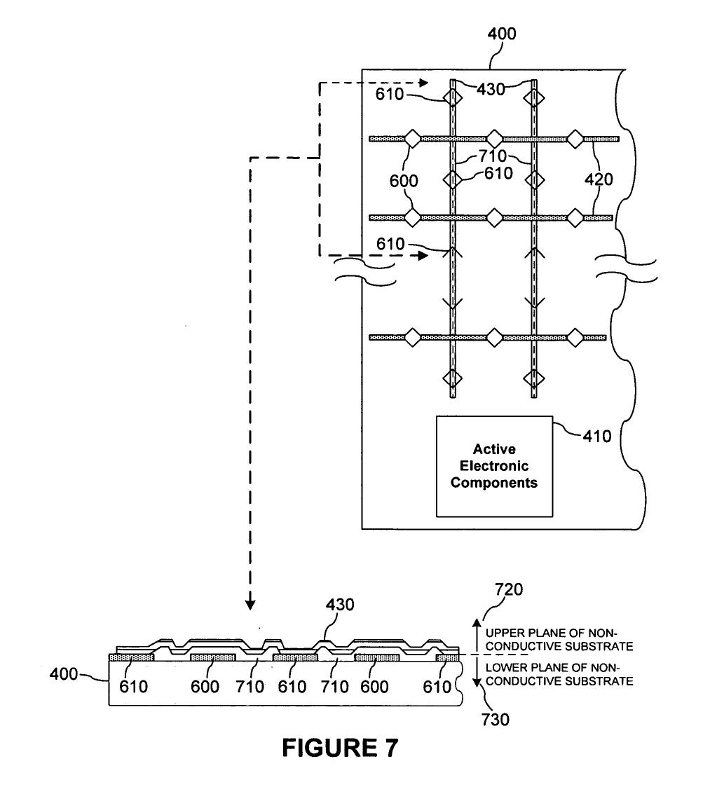

Metal may be used to dispose sensor traces 420 in the first direction. In addition, conductive ink may be used to dispose conductive sensor traces 430 in the second direction. Sensor traces 420 and 430 may intersect, where an insulator may be used to prevent an electrical connection between the intersecting sensor traces. Metallic conductive sensor traces on a non-conductive substrate are generally covered by a protective insulating layer known as a solder mask layer. This protective layer keeps the metal from oxidizing and corroding over time. FIG. 7 illustrates the location of solder mask layers 710 at the intersection of sensor traces 420 and 430.

The first set of sensor traces 420 disposed in the first direction lies on a substantially different plane than the second set of sensor traces 430 disposed in the second direction. FIG. 7 illustrates sensor traces 430 on a different plane than sensor traces 430. Although some portion of sensor traces 430 may dip into the lower plane 730 (otherwise occupied by insulation 710), sensor traces 430 cannot reside in the same area of the lower plane 730 occupied by sensor traces 420 and their corresponding sensor elements 600.

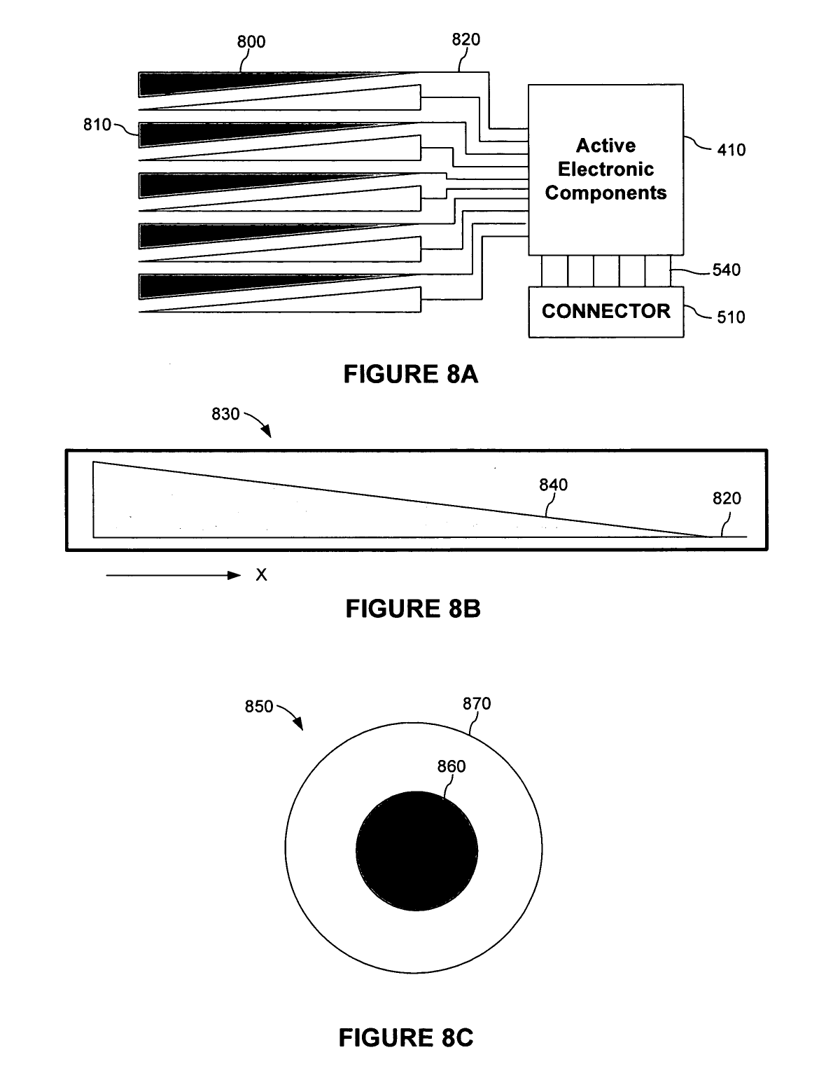

FIG. 8A illustrates an alternate embodiment of one or more sensor elements disposed on a single-layer non-conductive substrate, where one or more sensor traces 820 lie substantially on the same plane as one or more sensor elements 800 and 810. The structure of the sensor elements 800 and 810 in FIG. 8 may be referred to as tapered sensor elements. Alternatively, other types of touch-sensing devices may be used; for example, a linear touch-sensor slider and a touch-sensor button may be used.

FIG. 8A illustrates interleaved conductive sensor traces 800 and 810 across a touchpad surface, where each conductive sensor trace has a first end and a second end. The width of the first end is larger than the width of the second end. For example, sensor element 800 has one end that is wider than the other end of the sensor element. The interleaved conductive sensor traces have a first group of conductive sensor traces 800 alternated with a second group of conductive sensor traces 810.

Sensor traces 820 connect the tapered sensor elements 800 and 810 to the active electronic components 410 on one side of a non-conductive substrate. Due to the structure of the tapered sensor elements 800 and 810 and the layout of the sensor traces 820, as illustrated in FIG. 8A, sensor traces 820 do not need to intersect with each other to connect to active electronic components 410. As such, a single-type of sensor trace may be used to connect tapered sensor elements 800 and 810 to the active electronic components 410. For example, metal or conductive ink may be used to dispose sensor traces 820 onto the non-conductive substrate. More detail on metal and conductive ink traces are described above. The sensor traces 820 lie substantially on the same plane as the sensor elements 800 and 810 since the structure of the tapered sensor element does not require more than one type of sensor trace to connect sensor elements 800 and 810 to active electronic components 410. It should also be noted that the sensor elements 800 and 810 and sensor traces 820 may include similar or dissimilar conductive material. In another embodiment, the sensor elements 800 and 810 may be sensor traces themselves, and are directly coupled to the active electronic components 410 without the use of any additional conductive traces (e.g., 820 of FIG. 8A). In effect, the sensor elements 800 and 810 and the sensor traces 820 are the same conductive sensor elements.

FIG. 8B illustrates a conventional touch-sensor slider 830. The linear touch-sensor slider 830 includes a surface area on which a conductive object may be used to position a cursor in the x-axis (or alternatively, the y-axis). Touch-sensor slider 830 may include a one-dimensional sensor array. The linear touch-sensor slider structure 830 may also include one or more sensor elements that may be conductive sensor elements 840. Each sensor element may be connected between a conductive trace and a ground connection. For example, the sensor element 840 may be coupled to the active electronic components using a single conductive sensor trace 820. The sensor element 840 and sensor trace 820 of FIG. 8B may include similar or dissimilar conductive material. In another embodiment, the sensor element 840 may be sensor trace itself, and is directly coupled to the active electronic components 410 without the use of any additional conductive traces (e.g., 820 of FIG. 8B). By being in contact or in proximity on a particular portion of the slider structure, the capacitance between the conductive traces and ground varies and can be detected. The capacitance variation may be sent as a signal on the conductive trace to a controller. For example, by detecting the capacitance variation of each sensor element, the position of the changing capacitance can be pinpointed. In other words, it can be determined which sensor element has detected the presence of the conductive object, and it can also be determined the motion and/or the position of the conductive object.

FIG. 8C illustrates a conventional touch-sensor button 850. The operation of the touch-sensor button may be performed by detecting a presence of a conductive object on a sensing device having non-linearly disposed sensor elements that form inner 860 and outer sensing 870 areas, and recognizing a button operation on the sensing device when the presence of the conductive object is detected on the inner sensing area 860 of the sensing device. The touch-sensor button 850 may be used in touch-sensor pads for notebook cursor operations. Alternatively, the touch-sensor button 850 may be used in other applications, such as lighting control (e.g., dimmer), volume control, and speed control.

As previously discussed, the sensor elements, sensor traces, and active electronic components may be disposed on a single layer of a non-conductive substrate. In one embodiment, a first set of sensor traces may be disposed in a first direction coupling a first set of sensor elements in the first direction, where an example of the first direction is horizontal or vertical. Further, a second set of sensor traces may be disposed in a second direction coupling a second set of sensor elements in the second direction, where an example of the second direction is horizontal or vertical. The first direction may be substantially orthogonal to the second direction. Alternatively, other angles between the first direction and second may be used; for example, 30°, 45°, and 60° may also be used. The sensor elements and sensor traces may be made by conventional printed circuit fabrication, such as lithography and etching may be used. Lithography is the process of transferring patterns of geometric shapes on a mask to a thin layer of radiation-sensitive material (also known as resist), covering the surface of a semiconductor wafer. These patterns define the various regions in an integrated circuit such as the sensor elements of the sensing device. The resist patterns defined by the lithographic process are not permanent elements of the final device but only replicas of circuit features. The pattern transfer is accomplished by an etching process which selectively removes unmasked portions of a layer. The etching process may include wet chemical etching, plasma etching, or dry etching techniques to remove portions of the conductive materials.

One type of lithography is photolithography (also known as optical lithography). In photolithography the resist is a photoresist layer. Photoresist is a chemical that hardens when exposed to light (often ultraviolet). The photoresist layer is selectively “hardened” by illuminating it in specific places. A transparent plate, also referred to as a photomask, is used in conjunction with a light source to shine light on specific areas of the photoresist. The photomask includes the predetermined pattern printed on it.

The photoresist layer can be exposed using shadow printing or projection printing. In shadow printing the mask and the wafer may be in direct contact with, or in close proximity to, one another to directly image the pre-determined pattern of the photomask onto the photoresist layer. In projection printing, exposure tools have been developed to project an image of the mask patterns onto a resist-coated wafer to produce the pre-determined pattern on the photoresist layer.

Photoresists can be classified as positive and negative. Positive photoresists are used in additive photolithography techniques, and negative photoresists are used in the subtractive photolithography techniques. The positive and negative photoresists differ in how they respond to radiation. For positive resists, the exposed regions become more soluble and thus more easily removed in the development process. The net result is that the patterns formed on the photoresist are the same as on the mask. In contrast, the negative resists are the reverse of the mask patterns. In negative resists the exposed regions become less soluble, forming the inverse of the desired pattern.

The second set of sensor elements disposed in the second direction (e.g., vertical or horizontal) on the non-conductive substrate 400 may be conductive ink, such as carbon ink, or alternatively, the conductive sensors that interconnect metal sensor elements may be conductive ink. The sensor elements may be conductive sensor traces of the conductive ink, or alternatively, the sensor elements may be metal, such as copper, and the sensor traces that connect the sensor element to the active electronic components 410 (or to other sensor elements) may be conductive ink. The conductive ink may be applied to the non-conductive substrate 400 using known manufacturing techniques, such as screen printing. For example, screen printing may include selectively applying (e.g., screen-printed) layer of ink loaded with graphite to connect the second set of sensor elements to the active electronic components 410, or alternatively, to connect sensor elements to each other. Carbon and other types of conductive inks may be used to provide interconnections between the second set of sensor elements in the same layer as the first set of sensor elements. Both the first and second set of sensor elements are disposed on the same side of the non-conductive substrate 400.

In one embodiment, an insulator may be provided at each intersection of a metal trace and a conductive ink trace. The conductive ink of the sensor traces of the second set of sensor elements may cross the metal sensor traces of the first set of sensor elements at some places in the layer; however, by providing an insulator at those intersections, no electrical connection is formed between the two conductive materials. This insulator may be a solder mask insulator. The insulator may be selectively applied above the first set of sensor elements (and corresponding sensor traces) in a selective pattern. The insulator may also prevent the metal from oxidizing and corroding over time.

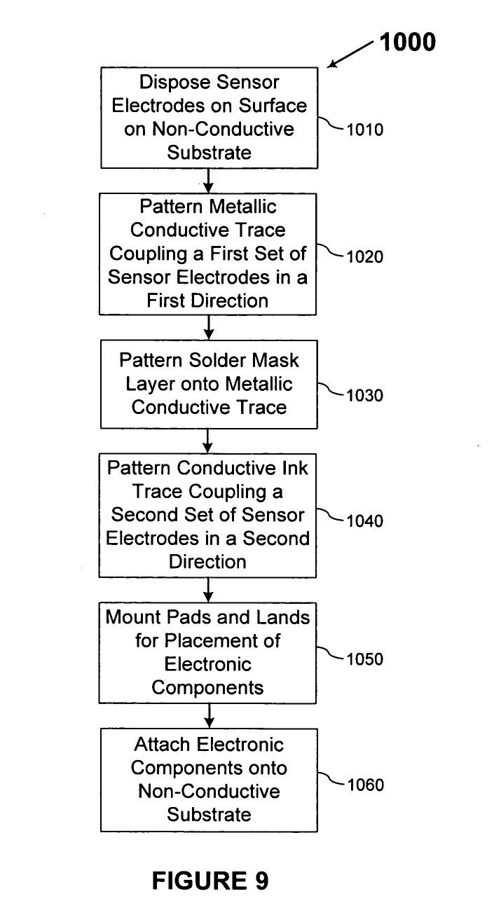

FIG. 9 illustrates a method to manufacture a single-layer touch-sensor device according to one embodiment of the present invention. In step 1010, one or more sensor elements are disposed on the surface of a non-conductive substrate. In an embodiment where the touch sensor device has an array of sensor elements, a first set of sensor elements are disposed in a first direction and a second set of sensor elements are disposed in second direction. The two sets of sensor elements may form a sensor array.

In step 1020, a conductive metal, such as copper, is patterned onto a non-conductive substrate, such that the conductive metal couples the first set of sensor elements in the first direction. One method to pattern copper is by depositing copper sensor traces onto the bare substrate using a sputtering process. An alternative and cost-effective method to pattern copper adheres a layer of copper over the entire substrate, sometimes on both sides, and then removes unwanted copper after applying a temporary mask, for example, by etching.

Silk screen printing is one method of etching used in the manufacturing of PCBs. Silk screen printing uses etch-resistant inks to protect the copper foil. Subsequent etching removes the unwanted copper. Alternatively, photoengraving is also used as an etching process in the manufacturing of PCBs. Photoengraving uses a photomask and chemical etching to remove the copper foil from the substrate. The photomask is usually prepared with a photoplotter from data produced by a technician using computer-aided PCB design software. Laser-printed transparencies are sometimes employed for low-resolution photoplots. Another alternative of etching is called PCB milling, which uses a 2- or 3-axis mechanical milling system to mill away the copper foil from the substrate.

In step 1030, a solder mask layer is patterned onto the copper sensor traces. As noted previously, the solder mask layer insulates the copper sensor traces and protects the sensor traces from oxidation and corrosion over time. The solder mask layer is often plated onto the substrate, where a tin-lead alloy or a gold-plated material may be used.

In step 1040, a conductive ink, such as carbon ink, is patterned onto the non-conductive substrate using a silk screen printing process, such that the conductive ink couples the second set of elements in the second direction. In coupling the second set of elements in the second direction, the carbon ink sensor traces may intersect the copper sensor traces in the first direction. No electrical connection, however, is made between the carbon ink sensor trace and the copper sensor trace since a solder mask layer insulates the copper sensor traces from the carbon ink sensor traces.

In step 1050, the pads and lands to which electronic components will be mounted are typically plated, because bare copper is not readily solderable. Next, in step 1060, electronic components are attached to the non-conductive substrate. Electronic components may be attached to the non-conductive substrate using a through-hole construction, where the electronic component's leads may be inserted and electrically and mechanically fixed to the board with a molten metal solder. Alternatively, the electronic components may be attached to the non-conductive substrate using a surface-mount construction. In surface-mount construction, the electronic components are soldered to pads or lands on the surface of the substrate.

The single-layer touch-sensor device described herein may be used in various applications. In one embodiment, the single-layer touch-sensor device discussed herein may be used in electronic devices, such as a laptop computer or PDA, to replicate a mouse's X/Y movement on an electronic display. Alternatively, the single-layer touchpad device herein may be used in other types of applications; for example, it may be used in mobile communication devices, portable entertainment devices (such as handheld video game devices, multimedia players, and the like), and other human interface devices (HIDs).

The touch-sensor device described herein provides a means for forming a single-layer touch-sensor device, where one or more sensor elements, one or more sensor traces, and active electronic components reside on a single layer of a non-conductive substrate without any other sensor traces residing on a different layer. As such, the cost to manufacture a touch-sensor device is reduced. The single-layer touch-sensor device described herein also provides a means for disposing one or more sensor traces on the non-conductive substrate to connect the active electronic components to the one or more sensor elements; therefore, fabrication of a single-layer touch-sensor device may be achieved.

Although the specific invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative manner rather than a restrictive sense.

What is claimed is:

1. A touch-sensor device, comprising:
a sensor element;
an active electronic component; and
a sensor trace coupled to the sensor element and the active electronic component, wherein the sensor element, active electronic component, and sensor trace are disposed on a single layer without any other sensor trace residing on a different layer.

2. The touch-sensor device of claim 1, wherein the sensor element comprises a metal sensor element and the active electronic component comprises a controller.

3. The touch-sensor device of claim 1, wherein the single layer comprises a same side of a non-conductive substrate.

4. The touch-sensor device of claim 1, further comprising a connector coupled to the active electronic component, wherein the connector is disposed on a same side of the non-conductive substrate as the single layer.

5. The touch-sensor device of claim 1, further comprising a ground plane disposed on a different side of the non-conductive substrate opposite of the side with the single layer.

6. The touch-sensor device of claim 5, wherein the ground plane comprises a conductive ink.

7. The touch-sensor device of claim 5, wherein the ground plane is a carbon printed ground plane.

8. The touch-sensor device of claim 5, wherein the ground plane is a ground grid.

9. The touch-sensor device of claim 5, further comprising a system ground disposed on the same side as the single layer, wherein the ground plane is coupled to the system ground using a pressure contact.

10. The touch-sensor device of claim 9, wherein the pressure contact comprises a spring conductive clip coupled between the ground plane and the system ground.

11. The touch-sensor device of claim 1, wherein the sensor trace comprises conductive ink.

12. The touch-sensor device of claim 11, wherein the conductive ink comprises carbon ink.

13. The touch-sensor device of claim 1, further comprising:
a first set of sensor traces disposed in a first direction coupling a first set of sensor elements in the first direction; and
a second set of sensor traces disposed in a second direction coupling a second set of sensor elements in the second direction.

14. The touch-sensor device of claim 13, wherein the first set of sensor traces comprises metal and the second set of sensor traces comprises conductive ink.

15. The touch-sensor device of claim 14, wherein an insulator is provided at each intersection of a metal sensor trace and a conductive ink sensor trace.

16. The touch-sensor device of claim 13, wherein the first direction is substantially orthogonal to the second direction.

17. The touch-sensor device of claim 13, wherein the first set of sensor traces disposed in the first direction is on the same side of a non-conductive substrate as the second set of sensor traces disposed in the second direction.

18. The touch-sensor device of claim 13, wherein the first set of sensor traces disposed in the first direction lies on a substantially different plane than the second set of sensor traces disposed in the second direction.

19. The touch-sensor device of claim 1, wherein the sensor trace resides on a same plane as the sensor element.

20. The touch-sensor device of claim 1, wherein the sensor element is a tapered sensor element having a first end and a second end, wherein a width of the first end is larger than a width of the second end.

21. The touch-sensor device of claim 20, further comprising a plurality of the tapered sensor elements and a plurality of the sensor traces, wherein the plurality of sensor traces are configured to couple the plurality of tapered sensor elements to the active electronic component.

22. The touch-sensor device of claim 20, further comprising a plurality of the tapered sensor elements, wherein the plurality of tapered sensor elements are coupled to the active electronic component without sensor traces.

23. The touch-sensor device of claim 21, wherein the plurality of tapered sensor elements are interleaved.

24. The touch-sensor device of claim 21, wherein the plurality of sensor elements comprises a first group of sensor traces alternated with a second group of sensor elements.

25. A method of manufacturing a touch-sensor device, comprising:
providing a non-conductive substrate; and
disposing a sensor element, an active electronic component, and a sensor trace on a single layer, without disposing any other sensor trace on a different layer.

26. A method of manufacturing the touch-sensor device of claim 25, further comprising coupling the sensor element to the active electronic component using the sensor trace.

27. The method of manufacturing the touch-sensor device of claim 25, wherein disposing the sensor trace on the single layer comprises applying a conductive ink to the non-conductive substrate to form a sensor trace, wherein the sensor trace is configured to couple the sensor element to another sensor element or to the active electronic component.

28. The method of manufacturing the touch-sensor device of claim 27, wherein the conductive ink comprises a carbon ink.

29. The method of manufacturing the touch-sensor device of claim 25, further comprising:
disposing a first set of sensor traces in a first direction, the first set of sensor traces coupling a first set of sensor elements in the first direction; and
disposing a second set of sensor traces in a second direction, the second set of sensor traces coupling a second set of sensor elements in the second direction.

30. The method of manufacturing the touch-sensor device of claim 29, wherein
disposing the first set of sensor traces comprises disposing metal on the non-conductive substrate; and
disposing the second set of sensor traces comprises disposing conductive ink.

31. The method of manufacturing the touch-sensor device of claim 30, wherein
disposing metal comprises disposing copper; and
disposing conductive ink comprises disposing carbon ink.

32. The method of manufacturing the touch-sensor device of claim 29, further comprises disposing an insulator at each intersection of the first set of sensor traces and second set of sensor traces.

33. The method of manufacturing the touch-sensor device of claim 32, wherein disposing the insulator comprises disposing solder mask insulator.

34. The method of manufacturing the touch-sensor device of claim 25, wherein disposing the sensor element and sensor trace comprises disposing the sensor element and sensor trace substantially on a common plane.

35. The method of manufacturing the touch-sensor device of claim 25, further comprises disposing a plurality of tapered sensor elements and a plurality of sensor traces.

36. The method of manufacturing the touch-sensor device of claim 35, wherein disposing a plurality of tapered sensor elements comprises:
forming on a plane, a plurality of interleaved conductive sensor traces of a touch-sensor device on a non-conductive substrate, the tapered sensor elements comprising a plurality of interleaved conductive sensor traces,
wherein each conductive sensor trace has a first end and a second end, the width of the first end being larger than the width of the second end.

37. The method of manufacturing the touch-sensor device of claim 36, wherein forming the plurality of interleaved conductive sensor traces comprises forming a first group of conductive sensor traces alternated with a second group of conductive sensor traces.
